(19) United States
(12) Patent Application Publication
(10) Pub. No.: US 2011/0244131 A1
(43) Pub. Date: Oct. 6, 2011

(54) METHOD AND APPARATUS FOR TEMPLATE SURFACE TREATMENT, AND PATTERN FORMING METHOD

(76) Inventors: Yoshihisa KAWAMURA, Yokohama-shi (JP); Katsutoshi Kobayashi, Tokyo (JP); Shinichi Ito, Yokohama-shi (JP); Hidekazu Hayashi, Yokohama-shi (JP); Hiroshi Tomita, Yokohama-shi (JP)

(21) Appl. No.: 13/043,911

(22) Filed: Mar. 9, 2011

(30) Foreign Application Priority Data
Mar. 31, 2010 (JP) 2010-81019
Dec. 16, 2010 (JP) 2010-280514

(51) Int. Cl. B05D 5/02; B05D 3/10

(52) U.S. Cl. 427/256; 427/271; 118/72

(57) ABSTRACT

According to an embodiment, a template surface treatment method includes hydroxylating the surface of a template having an uneven pattern surface or absorbing water onto the surface to distribute OH radicals on the surface, and coupling a coupling agent onto the template surface on which the OH radicals are distributed. These processes are performed in an environment in which amines are controlled to be in a predetermined concentration or less.

### CROSS REFERENCE TO RELATED APPLICATIONS

This application is based upon and claims the benefit of priority from the prior Japanese Patent Applications No. 2010-81019, filed on Mar. 31, 2010, and No. 2010-280514, filed on Dec. 16, 2010, the entire contents of which are incorporated herein by reference.

### FIELD

Embodiments described herein relate generally to a template surface treatment method, a template surface treatment apparatus, and a pattern forming method.

### BACKGROUND

In recent years, as a fine pattern forming method, attention has been focused on a nanoimprinting method. In the nanoimprinting method, an imprint template formed with an uneven pattern is brought into contact with a resist coated onto a substrate to be processed to cure the resist, and the template is then released from the resist to form a resist pattern.

To easily release the template from the resist, a method for forming a release layer on the surface of the template is proposed (for instance, see T. Zhang et al, “Vapor Deposited Release Layers for Nanoimprint Lithography”, Proc. Of SPIE, Vol. 6151, 117, 2006). The release layer is conventionally formed, e.g., by immersing the template into a mold release agent solution, maintaining the solution adhering onto the surface at high temperature and at high humidity, and performing rinsing and drying.

However, in such processing, amines, moisture, organic substances, particles, and the like present on the surface of the unprocessed template, in the processing atmosphere, and in the mold release agent solution adhere onto the surface of the template. Accordingly, the uniformity of the formed release layer is deteriorated. When the template having the release layer with such deteriorated uniformity is used to form the resist pattern, defects are caused in the resist pattern.

### BRIEF DESCRIPTION OF THE DRAWINGS

FIG. 1 is a schematic block diagram of a template surface treatment apparatus according to a first embodiment of the present invention;

FIG. 2 is a flowchart of assistance in explaining a template surface treatment method according to the first embodiment;

FIGS. 3A, 3B, 3C, and 3D are schematic diagrams of steps of template surface treatment according to the first embodiment;

FIG. 4 is a schematic block diagram of a template surface treatment apparatus according to a second embodiment of the present invention;

FIG. 5 is a schematic diagram of particle removal;

FIGS. 6A and 6B are schematic diagrams of steps of template surface treatment according to the second embodiment;

FIG. 7 is a schematic block diagram of a template surface treatment apparatus according to a third embodiment of the present invention;

FIG. 8 is a diagram showing an example of the configuration of a first chamber of the surface treatment apparatus according to the third embodiment;

FIG. 9 is a diagram showing an example of the configuration of a second chamber of the surface treatment apparatus according to the third embodiment;

FIG. 10 is a diagram showing an example of the configuration of a storing unit of the surface treatment apparatus according to the third embodiment; and

FIG. 11 is a flowchart of assistance in explaining a template surface treatment method according to the third embodiment.

### DETAILED DESCRIPTION

According to an embodiment, a template surface treatment method includes hydroxylating the surface of a template having an uneven pattern surface or absorbing water onto the surface to distribute OH radicals on the surface, and coupling a coupling agent onto the template surface on which the OH radicals are distributed. These processes are performed in an environment in which amines are controlled to be in a predetermined concentration or less. Hereinafter, embodiments of the present invention will be described with reference to the drawings.

### First Embodiment

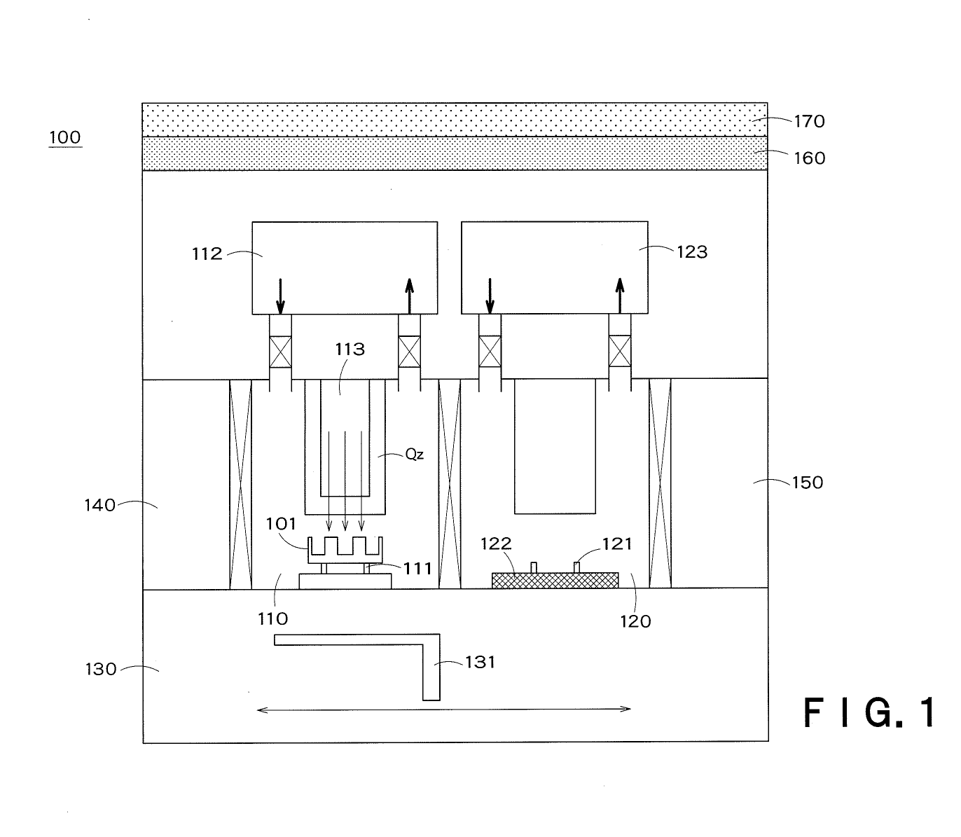

FIG. 1 shows the schematic configuration of a template surface treatment apparatus according to a first embodiment of the present invention. A surface treatment apparatus 100 has a first chamber 110, a second chamber 120, a conveying arm 131 which conveys a template along a conveying path 130, a loader unit 140 which sets the unprocessed template, and an unloader unit 150 which unloads the processed template. Partition walls are provided between the loader unit 140 and the first chamber 110, between the first chamber 110 and the second chamber 120, and between the second chamber 120 and the unloader unit 150, respectively.

Openable/closable shutters (not shown) can be provided on the side surfaces of each of the first chamber 110 and the second chamber 120. In FIG. 1, for convenience, the conveying arm 131 is located below the chamber. However, actually, the conveying arm 131 is provided at substantially the same height as the chamber, and can convey the template into the chamber or can convey the template out of the chamber via the shutters.

In addition, a first filter 160 and a second filter 170 are provided in the upper portion of the surface treatment apparatus 100. The first filter 160 is a HEPA filter which removes particles. The second filter 170 is a chemical filter which removes amines such as ammonia. The first filter 160 and the second filter 170 bring the interior of the surface treatment apparatus 100 into an environment in which there are very few particles and amines. For instance, amines are controlled to be in a several ppb level.

The first chamber 110 is a chamber which reacts OH radicals onto the surface of the template, and has a holding unit 111, a first gas supplying unit 112, and a light emitting unit 113.

The holding unit 111 holds a template 101 set by the loader unit 140 and conveyed by the conveying arm 131. The template 101 is, for instance, formed with an uneven pattern by plasma etching on a totally transparent quartz substrate used for a typical photomask.

The first gas supplying unit 112 supplies the mixed gas of H₂O/O₂/N₂ into the first chamber 110. The first gas supplying unit 112 can adjust the humidity in the first chamber 110 by controlling the mixing ratio and the flow rate of the mixed gas.

The light emitting unit 113 emits a light onto the uneven pattern surface of the template 101. The light emitting unit 113 has an Xe excimer lamp as a light source, and emits a light having a wavelength of 172 nm.

The light emitting unit 113 may emit the light onto the entire surface of the template 101 or may emit the light onto a portion of the template 101. Preferably, the light emitting unit 113 or the holding unit 111 is provided so as to be drivable in the plane direction or in the vertical direction so that the template 101 is movable relative to the light emitting unit 113. In addition, the light emission angle with respect to the surface of the template 101 may be adjustable.

The gas interposed between the light emitting unit 113 and the surface of the template 101 attenuates the light emitted from the light emitting unit 113. Therefore, the humidity and the oxygen concentration in the first chamber 113, the intensity of the light emitted from the light emitting unit 113, and the distance between the light emitting unit 113 and the surface of the template 101 are adjusted so that the light emitted from the light emitting unit 113 can reach the surface of the template 101.

In addition, the light emitting unit 113 is covered with quartz Qz. Thereby, contamination from the light emitting unit 113 onto the template 101 can be prevented.

The second chamber 120 is a chamber which supplies a coupling agent while heating the template, thereby causing coupling reaction, and has a holding unit 121, a heating unit 122, a second gas supplying unit 123, and a cooling unit (not shown).

The holding unit 121 holds the template 101 conveyed by the conveying arm 131 from the first chamber 110.

The heating unit 122 is, e.g., a heater, and heats the template 101 held by the holding unit 121. The heating unit 122 can adjust the surface temperature of the template 101.

The second gas supplying unit 123 supplies the mixed gas of a silane coupling agent and N₂ into the second chamber 120. For instance, the silane coupling agent contains Si and is hydrocarbon or fluorocarbon, with an alkoxy group (RO—) or an NHx (x=1, 2) group at an end.

The cooling unit cools the template 101. The cooling unit, for instance, holds the template 101 close to a cool plate to cool the template 101. In addition, the second gas supplying unit 123 may supply low-temperature dry air to cool the template.

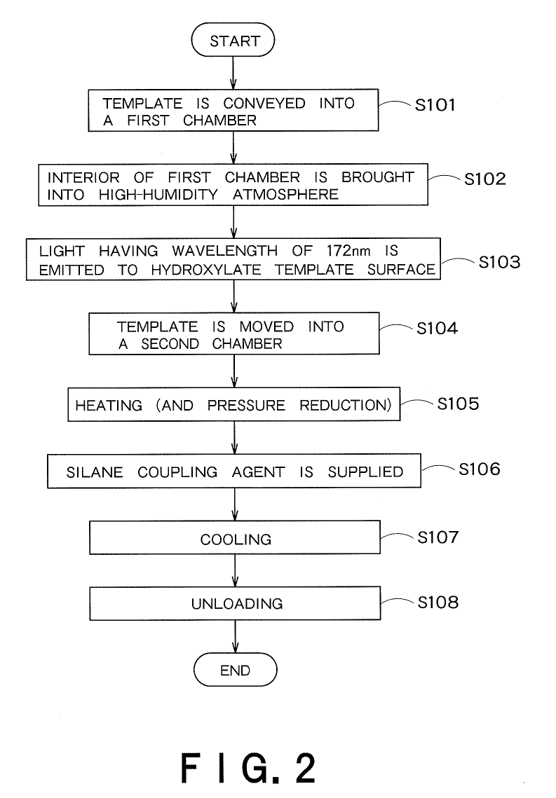

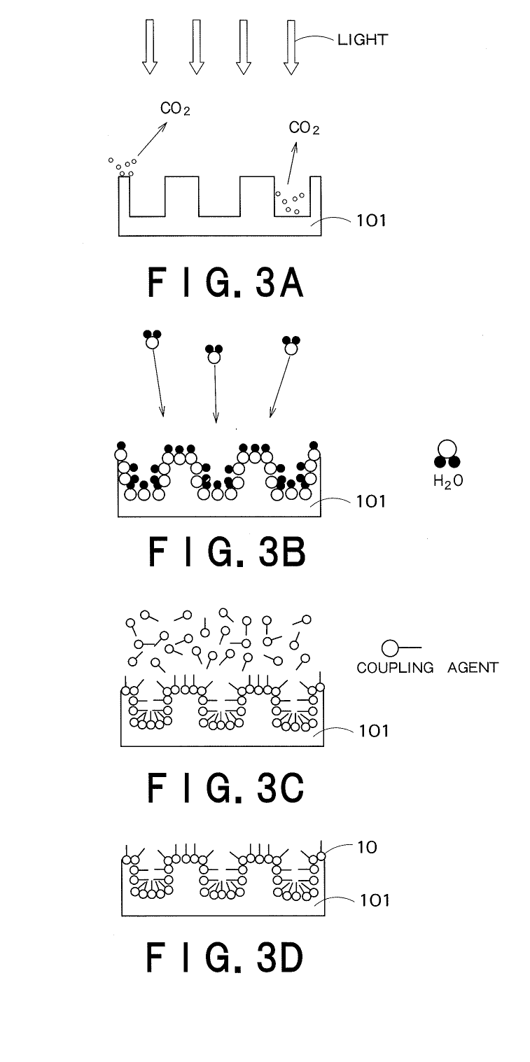

Next, a method for performing template surface treatment using such surface treatment apparatus 100 will be described with reference to FIGS. 1 to 3D. FIG. 2 is a flowchart of assistance in explaining a surface treatment method. FIGS. 3A, 3B, 3C, and 3D are schematic diagrams of steps of the template surface treatment.

(Step S101) The template 101 having an uneven pattern surface is set to the loader unit 140 of the surface treatment apparatus 100. Since an atmosphere which has passed through the filters 160 and 170 is supplied into the surface treatment apparatus 100, amines are controlled to be in a several ppb level and there are very few particles. The conveying arm 131 conveys the template 101 from the loader unit 140 into the first chamber 110. The conveyed template 101 is held by the holding unit 111.

(Step S102) The first gas supplying unit 112 supplies the mixed gas of H₂O/O₂/N₂ into the first chamber 110. Thereby, the interior of the first chamber 110 is brought into a high-humidity atmosphere.

(Step S103) The light emitting unit 113 emits the light having a wavelength of 172 nm onto the surface of the template 101. Thereby, the surface of the template 101 acts on oxygen in the atmosphere to generate ozone, and then, oxygen radicals having strong oxidizability are formed. As a result, as shown in FIG. 3A, organic substances are removed.

In addition, the siloxane bond (Si—O—Si) on the surface of the quartz template 101 cleaned by light emission is hydroxylated by the OH radicals, and as shown in FIG. 3B, silanol groups (Si—OH) are distributed uniformly and densely. At this time, moisture is excessively absorbed onto the silanol groups.

(Step S104) The light emitting unit 113 stops light emission, and the first gas supplying unit 112 stops the supply of the mixed gas. Then, the template 101 is moved into the second chamber 120 by the conveying arm 131. The template 101 moved into the second chamber 120 is held by the holding unit 121.

(Step S105) The heating unit 122 heats the template 101 at a temperature of 180° C. Thereby, moisture excessively absorbed onto the OH sites on the surface of the template 101 is removed. Preferably, the heating is performed within the range between 100 and 200° C., in which the excessively absorbed water is removed and the OH radicals distributed on the surface of the template 101 are not desorbed.

A suction and pressure-reduction mechanism may be provided in the second chamber 120 to reduce the pressure in the second chamber 120 with heating. For instance, preferably, the interior of the second chamber 120 is reduced to 10⁻⁵ Pa or less.

(Step S106) The heating unit 122 continues heating. Moisture in the atmosphere in the second chamber 120 is measured by a sensor, not shown, and after the moisture is reduced to a ppb order, the second gas supplying unit 123 supplies the mixed gas of the silane coupling agent and the dry N₂ into the second chamber 120. As shown in FIG. 3C, the hydrolyzable groups (e.g., methoxy groups) of the silane coupling agent has a hydrolyzable reaction with a very small amount of moisture remaining in the atmosphere to form silanol groups, followed by the dehydration condensation reaction with the silanol groups on the surface of the quartz template 101 to cause coupling reaction.

(Step S107) The heating unit 122 stops heating, and the cooling unit cools the template 101.

(Step S108) The template is unloaded from the unloader unit 150.

The surface of the template 101 hydroxylated in step S103 easily absorbs ammonia and amines. In addition, since ammonia, amines, moisture, and alcohol are by-products resulting from the coupling reaction, these substances are present in the reaction site to prevent the coupling reaction. However, in the present embodiment, the chemical filter 170 provides a processing environment in which the amine concentration is reduced to a very low level. In addition, by pressure reduction and heating, reaction products unnecessary for the coupling reaction can be removed. Thereby, the coupling reaction can be effectively advanced.

In addition, when excessive moisture is present in the atmosphere at the time of the coupling reaction, the coupling reaction is caused in the atmosphere, resulting in coupling agent aggregation, thereby causing particles. For this reason, the reactive species are reduced, and the by-products such as amines and particles caused in the reaction adhere onto the surface of the template 101 as the reaction site to prevent the coupling reaction. However, in the present embodiment, since dry nitrogen is supplied and heating is performed, the interior of the second chamber 120 can be held at very low humidity. Further, the concentration of the by-products such as amines caused during the coupling reaction may be reduced to low concentration. For instance, when the silane coupling agent is supplied in vapor form, the reaction atmosphere is circulated between the second chamber 120 and the second gas supplying unit 123 during the coupling reaction to remove the reaction by-products. In this case, desirably, the chemical filter is provided in the circulation path.

Further, in the present embodiment, since heating is performed while the coupling reaction is performed, the by-product amines caused by the coupling reaction can be immediately removed from the reaction site, the coupling reaction can be performed uniformly and densely on the surface of the template 100, and as shown in FIG. 3D, a uniform and strong release layer 10 can be formed on the surface of the template 101.

The template 101 formed with the release layer by such processing is used for pattern forming by the following imprint method. First, an imprint material is applied onto a substrate to be processed. Thereafter, the template 101 subjected to the above surface treatment is brought into contact with the imprint material. In this state, the imprint material is cured. Then, the template is released from the imprint material to form a pattern on the substrate to be processed. The defect density of the pattern formed using the template 101 subjected to the surface treatment according to the present embodiment is reduced to 0.1 piece/cm² or less. In addition, the life of the template 101 can be longer.

In this way, the template 101 subjected to the surface treatment according to the present embodiment is used so that the imprint quality can be improved. Accordingly, the productivity of storage devices and LEDs manufactured using the imprint can be enhanced.

In the first embodiment, the vaporized silane coupling agent is used when the coupling reaction is caused (in Step S106). However, the surface of the template 101 may be spin coated, spray coated, or roll coated with a liquid coupling agent (a liquid in which a coupling agent is dissolved into a solvent) . In addition, using chemical vapor deposition, physical vapor deposition, a crystal growth method, or a vapor deposition method, a film of the silane coupling agent may be formed on the surface of the template 101. Further, the silane coupling agent into which a catalyst such as a silanol catalyst is mixed may be supplied onto the surface of the template 101. When the silane coupling agent is supplied in liquid form, the silane coupling agent can be circulated between the second chamber 120 and a silane coupling agent supplying unit (not shown) during the coupling reaction to remove the reaction by-products. In this case, desirably, a filter which removes the by-products is provided in the circulation path.

In the first embodiment, the surface of the template reacts with the OH radicals. However, there is a method in which the surface of the template does not directly react with the OH radicals. First, in the first chamber 110, the light emitting unit 113 emits a light having a wavelength of 252 nm to make the surface of the template 101 hydrophilic. In this step, ozone may act on the surface of the template 101.

Subsequently, the first gas supplying unit 112 supplies the mixed gas of H₂O/O₂/N₂ into the first chamber 110 to allow the high-humidity atmosphere to act on the surface of the template 101. Thereby, water is absorbed onto the surface of the template 101.

The template 101 is moved into the second chamber 120, and is heated at about 180° C. by the heating unit 122 under reduced pressure. Thereby, moisture excessively absorbed onto the surface of the template 101 is removed, and an absorbed water mono-layer on the surface of the template 101 is formed.

Then, the second gas supplying unit 123 supplies the mixed gas of the silane coupling agent and the dry N₂ to allow the silane coupling agent to act on the absorbed water layer to cause the coupling reaction. Since the excessively absorbed water is removed by heating, the coupling reaction can be effectively advanced.

By such method, as in the first embodiment, as shown in FIG. 3D, the uniform and strong release layer 10 can be formed on the surface of the template 101.

### Second Embodiment

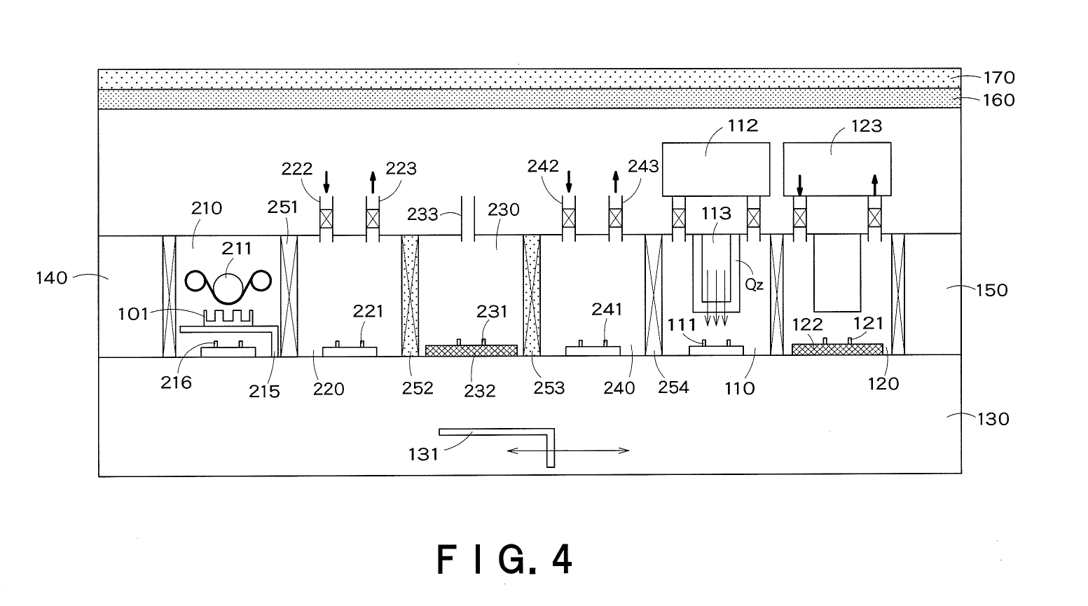

FIG. 4 shows the schematic configuration of a template surface treatment apparatus according to a second embodiment of the present invention. A surface treatment apparatus 200 further includes chambers 210 to 240 between the loader unit 140 and the first chamber 110 of the surface treatment apparatus 100 according to the first embodiment shown in FIG. 1.

The conveying arm 131 moves the template 101 between the chambers. Since the first filter 160 and the second filter 170 are provided in the upper portion of the surface treatment apparatus 200, the interior of the apparatus is held in an environment in which there are very few particles and amines.

In FIG. 4, the same parts as the first embodiment shown in FIG. 1 are indicated by the same reference numerals and the description for such parts will not be repeated.

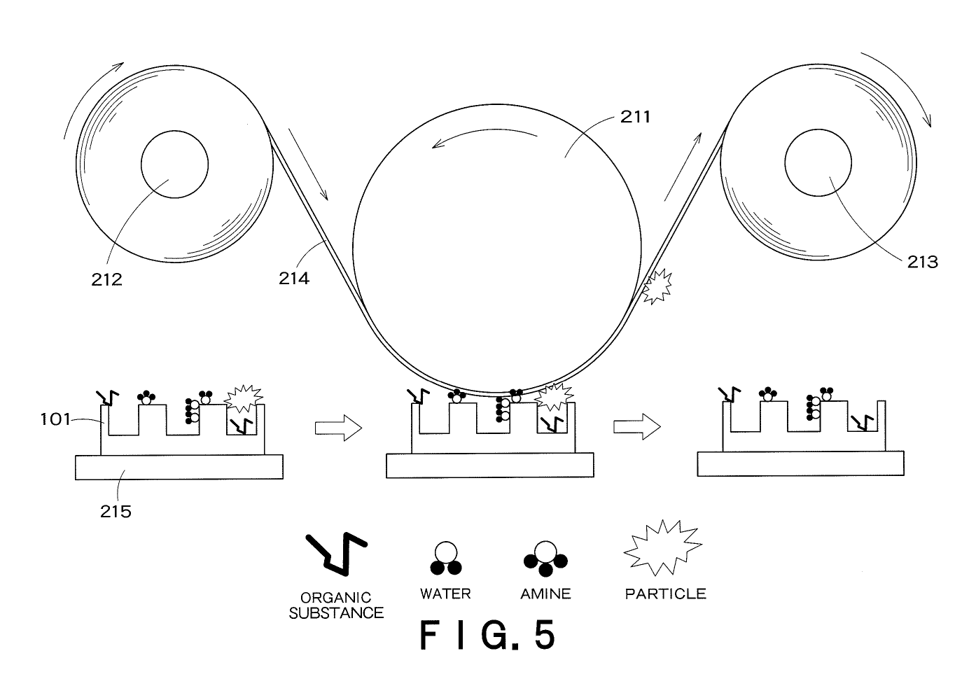

The chamber 210 removes inorganic substance particles, such as metal and Si, which adhere onto the surface of the template 101. FIG. 5 shows a schematic diagram of the chamber 210. The chamber 210 has a pressing roll 211, reels 212 and 213, an adhesive sheet 214, and a conveying stage 215.

The adhesive sheet 214 is a sheet in which an acrylic adhesive layer is formed on a polyvinyl chloride (PVC) substrate.

The reel 212 is rotated in the direction for rewinding the roll-like adhesive sheet 214 (in the clockwise direction in the drawing) to rewind the adhesive sheet 214.

The reel 213 is rotated in the direction for winding the adhesive sheet 214 (in the clockwise direction in the drawing) to wind the adhesive sheet 214 in roll form.

The conveying stage 215 conveys the template 101 (in the right-hand direction in the drawing) so as to pass below the pressing roll 211.

While being rotated in the direction for feeding the adhesive sheet 214 (in the counterclockwise direction in the drawing), the pressing roll 211 presses or separates the adhesive sheet 214 onto or from the surface of the template 101 conveyed by the conveying stage 215. Thereby, inorganic substance particles are removed from the surface of the template 101.

FIG. 4 shows a holding unit 216 which holds the template 101 onto the chamber 210. However, when the conveying stage 215 directly conveys the template 101 into and out of the chamber 210 between the conveying stage 215 and the conveying arm 131, the holding unit 216 may not be necessarily used.

The chamber 230 shown in FIG. 4 is a chamber which removes water and amine molecules absorbed onto the surface of the template 101, and has a holding unit 231, a heating unit 232, and a suction port 233.

The holding unit 231 holds the template 101 from which inorganic substance particles are removed in the chamber 210.

The heating unit 232 is, e.g., a heater, and heats the template 101 held by the holding unit 231. The heating unit 232 preferably heats the template 101 at a temperature of about 150° C. to 200° C.

The suction port 233 is coupled to a suction mechanism, not shown, and the gas in the chamber 230 is discharged via the suction port 233 to reduce the pressure in the chamber.

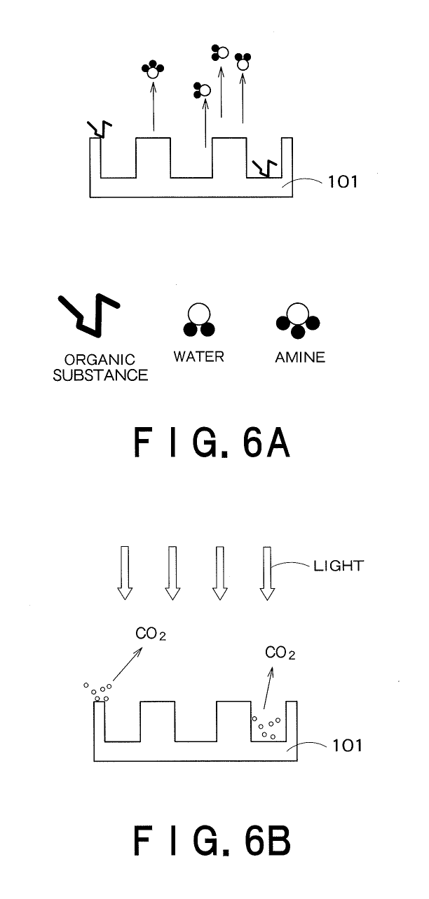

By heating and pressure reduction, as shown in FIG. 6A, absorbed molecules are removed from the surface of the template 101. Organic substances remaining on the surface of the template 101 are removed by emitting a light having the wavelength of 172 nm, as shown in FIG. 6B (which is the same drawing as FIG. 3A), in the first chamber 110.

The interior of the chamber 230 is in the pressure reduction state, and is in an environment (inner pressure) different from that of the chamber 210 and the first chamber 110 whose processes are performed before and after the process in the chamber 230. For this reason, the chambers (load lock chambers) 220 and 240 constituting load lock chambers are provided between the chambers 210 and 230 and between the chamber 230 and the first chamber 110, respectively.

The load lock chamber 220 has a holding unit 221, a gas supply port 222, and a suction port 223. The holding unit 221 holds the template 101 subjected to the process in the chamber 210. The suction port 223 is coupled to a suction mechanism, not shown, and the pressure in the chamber can be reduced. Nitrogen gas (inert gas) is supplied from a gas supplying unit, not shown, via the gas supply port 222 into the load lock chamber 220 so that the interior of the chamber can be brought into a nitrogen gas atmosphere.

The load lock chamber 240 has a holding unit 241, a gas supply port 242, and a suction port 243. The holding unit 241 holds the template 101 subjected to the process in the chamber 230. The suction port 243 is coupled to a suction mechanism, not shown, and the pressure in the chamber can be reduced. Nitrogen gas (inert gas) is supplied from a gas supplying unit, not shown, via the gas supply port 242 into the load lock chamber 240 so that the interior of the chamber can be brought into a nitrogen gas atmosphere.

The load lock chambers 220 and 240 and the chamber 230 are partitioned by gate valves 252 and 253, respectively. For instance, when the template 101 is conveyed from the load lock chamber 220 into the chamber 230, the pressure in the load lock chamber 220 is reduced before opening the gate valve 252. In addition, for instance, when the template 101 is conveyed from the chamber 230 into the load lock chamber 240, the pressure in the load lock chamber 240 is reduced before opening the gate valve 253.

A partition wall 251 is provided between the chamber 210 and the load lock chamber 220, and a partition wall 254 is provided between the load lock chamber 240 and the first chamber 110.

The side surfaces of each of the chamber 210 and the load lock chambers 220 and 240 can have shutters (not shown) which can convey the template 101 with the conveying path 130, like the first chamber 110 and the second chamber 120. Further, conveying mechanisms, not shown, may be additionally provided between the load lock chamber 220 and the chamber 230, and between the chamber 230 and the load lock chamber 240, respectively.

Since such surface treatment apparatus 200 removes inorganic substance particles and absorbed molecules on the surface of the template before the template surface treatment according to the first embodiment is performed, the uniform and strong release layer can be formed on the surface of the template. In addition, since the surface of the template is cleaned in the chambers 210 and 230 before the release layer is formed, the uniform release layer can be formed again followed by once removing the partially defected release layer.

### Third Embodiment

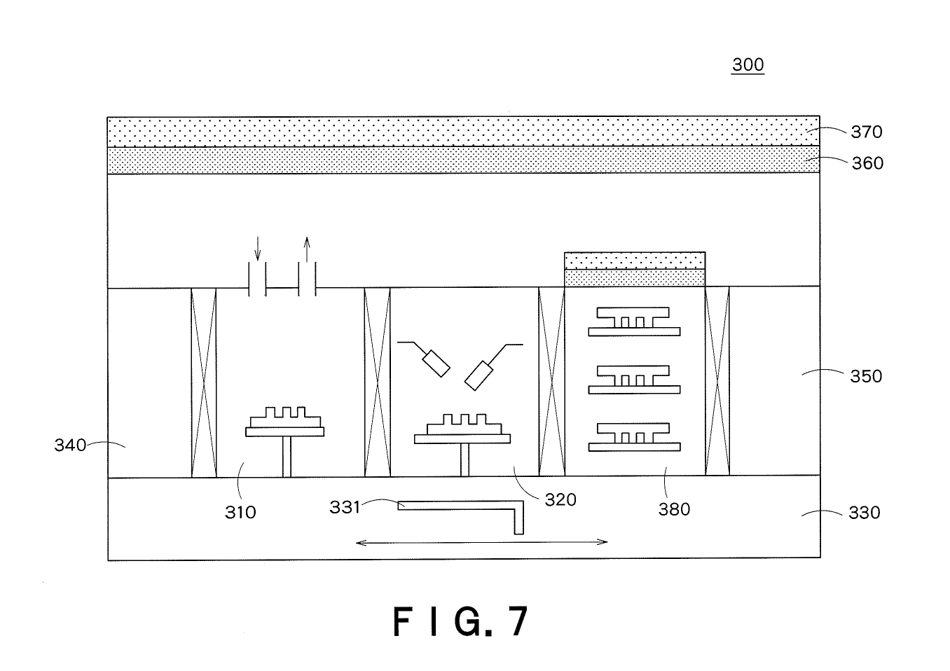

FIG. 7 shows the schematic configuration of a template surface treatment apparatus according to a third embodiment of the present invention. A surface treatment apparatus 300 has a first chamber 310, a second chamber 320, a conveying arm 331 which conveys a template along a conveying path 330, a loader unit 340 which sets the unprocessed template, a storing unit 380 which stores the processed template, and an unloader unit 350 which unloads the template stored in the storing unit 380.

Partition walls are provided between the loader unit 340 and the first chamber 310, between the first chamber 310 and the second chamber 320, between the second chamber 320 and the storing unit 380, and between the storing unit 380 and the unloader unit 350, respectively.

Openable/closable shutters (not shown) can be provided on the side surfaces of each of the first chamber 310, the second chamber 320, and the storing unit 380. In FIG. 7, for convenience, the conveying arm 331 is located below the chamber. However, actually, the conveying arm 331 is provided at substantially the same height as the chamber, and can convey the template into or out of the chamber via the shutters.

In addition, a first filter 360 and a second filter 370 are provided in the upper portion of the surface treatment apparatus 300. The first filter 360 is a HEPA filter which removes particles. The second filter 370 is a chemical filter which removes amines such as ammonia. The first filter 360 and the second filter 370 bring the interior of the surface treatment apparatus 300 into an environment in which there are very few particles and amines. For instance, amines are controlled to be in a several ppb level.

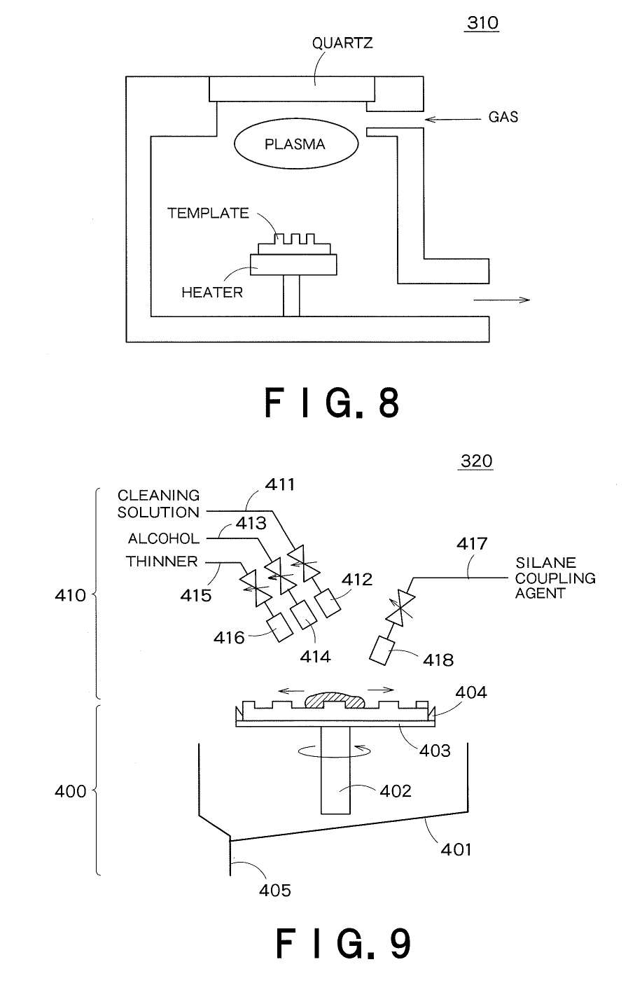

The first chamber 310 is a chamber which removes organic substances such as resist residuals remaining on the surface of the template, and ashes and removes the organic substances by plasma ashing. FIG. 8 shows an example of the configuration of the first chamber 310.

The second chamber 320 is a chamber which supplies a chemical solution onto the surface of the template and removes inorganic substance particles remaining on the surface of the template. In addition, coupling reaction is caused in the second chamber 320 to form the release layer on the surface of the template. In the second chamber 320, the uniform release layer is formed without drying the surface of the template. Defects such as drying traces (water marks) are caused by drying the surface of the template, and further, imprint defects can be caused. Therefore, the coupling reaction is executed without drying the surface of the template during the cleaning of the template, so that contamination on the surface of the template before the release layer is formed can be prevented, the uniform and strong release layer can be formed, and defects at the time of imprint can be reduced.

Specifically, as shown in FIG. 9, the second chamber 320 has a holding and rotating unit 400 which holds and rotates a template 301, and a chemical solution supplying unit 410.

The holding and rotating unit 400 has a spin cup 401, a rotational shaft 402, a spin base 403, and a chuck pin 404. The rotational shaft 402 is extended in the substantially vertical direction, and the disc-like spin base 403 is attached to the upper end of the rotational shaft 402. The rotational shaft 402 and the spin base 403 can be rotated by a motor, which is not shown.

The chuck pin 404 is provided at the circumferential edge of the spin base 403. The chuck pin 404 grips the template 301, so that the holding and rotating unit 400 can substantially horizontally hold and rotate the template 301.

When the chemical solution is supplied from the chemical solution supplying unit 410 to near the rotation center on the surface of the template 301, the chemical solution spreads in the outer circumferential direction of the template 301. In addition, the holding and rotating unit 400 can perform spin drying of the template 301. The excessive chemical solution splashed in the outer circumferential direction of the template 301 is trapped by the spin cup 401, and is discharged via a solution discharge pipe 405.

The chemical solution supplying unit 410 can supply a cleaning solution, alcohol, thinner, and a silane coupling agent onto the surface of the template 301. The cleaning solution is supplied via a supply line 411, and is discharged from a nozzle 412. As the cleaning solution, for instance, sulfuric acid, hydrofluoric acid, hydrochloric acid, and hydrogen peroxide can be used.

Likewise, the alcohol is supplied via a supply line 413, and is discharged from a nozzle 414. As the alcohol, for instance, isopropyl alcohol and ethanol can be used.

Thinner is supplied via a supply line 415, and is discharged from a nozzle 416. As the thinner, for instance, hexane, PGME, PGMEA, and y-butyrolactone can be used.

The silane coupling agent is supplied via a supply line 417, and is discharged from a nozzle 418. For instance, the silane coupling agent contains Si and is hydrocarbon or fluorocarbon, with an alkoxy group (RO—) or an NHx (x=1, 2) group at an end.

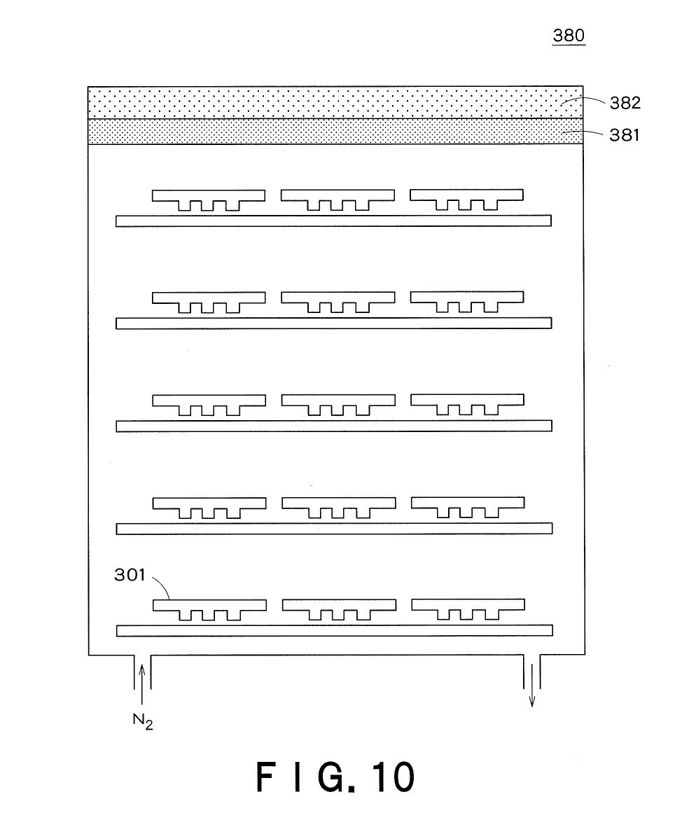

Next, the storing unit 380 will be described with reference to FIG. 10. The storing unit 380 stores the template 301 in which the release layer is formed in the second chamber 320.

As shown in FIG. 10, a HEPA filter 381 which removes particles and a chemical filter 382 which removes amines such as ammonia are provided in the upper portion of the storing unit 380. For this reason, the interior of the storing unit 380 is in an environment in which there are fewer particles and amines than the first chamber 310 and the second chamber 320, and the amine concentration and the number of particles are controlled to be in a predetermined value or less. In addition, a nitrogen gas (inert gas) is supplied into the storing unit 380 so that the interior of the storing unit 380 is brought into a nitrogen gas atmosphere.

The template 301 is stored in such storing unit 380 until the time immediately before the resist pattern forming, so that the release layer can be prevented from being contaminated during the storing.

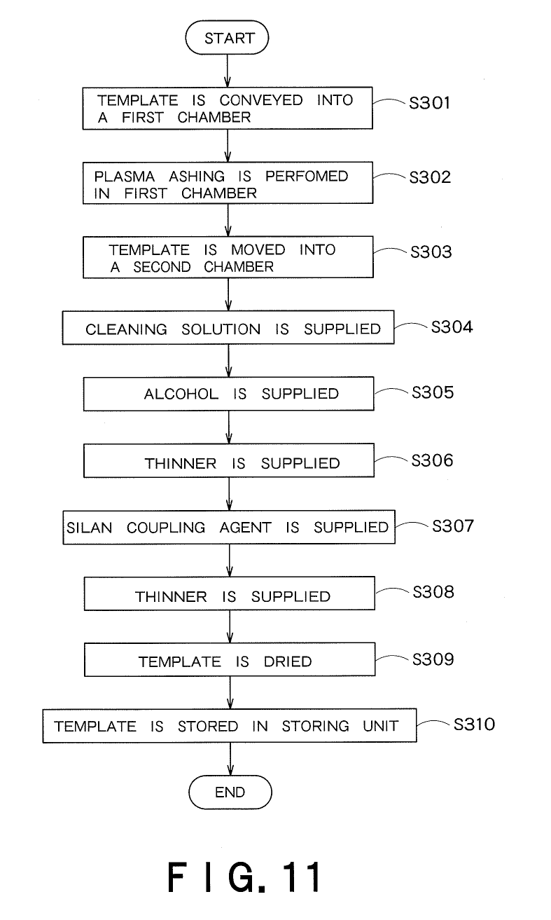

Next, a method for performing the surface treatment of the template 301 using such surface treatment apparatus 300 will be described with reference to the flowchart shown in FIG. 11. Here, the template 301 is formed with, for example, an uneven pattern by plasma etching on a totally transparent quartz substrate used for a typical photomask.

(Step S301) The template 301 having an uneven pattern surface is set to the loader unit 340 of the surface treatment apparatus 300. Since an atmosphere which has passed through the filters 360 and 370 is supplied into the surface treatment apparatus 300, amines are controlled to be in a several ppb level and there are very few particles. The conveying arm 331 conveys the template 301 from the loader unit 340 into the first chamber 310.

(Step S302) Plasma ashing is performed in the first chamber 310 to remove organic substances such as resist residuals remaining on the surface of the template 301.

(Step S303) The conveying arm 331 conveys the template 301 from the first chamber 310 into the second chamber 320. The conveyed template 301 is gripped by the chuck pin 404 shown in FIG. 9.

(Step S304) The template 301 is rotated at a predetermined rotational speed to supply the cleaning solution from the chemical solution supplying unit 410 to near the rotation center of the surface of the template 301. The cleaning solution spreads over the entire region on the surface of the template 301 due to centrifugal force generated by the rotation of the template 301 to perform the cleaning process of the template 301. Thereby, inorganic substance particles remaining on the surface of the template 301 are removed.

(Step S305) The alcohol is supplied from the chemical solution supplying unit 410 to near the rotation center of the surface of the template 301. The alcohol is spread over the entire region on the surface of the template 301 due to centrifugal force generated by the rotation of the template 301. Thereby, the cleaning solution remaining on the surface of the template 301 is substituted with the alcohol.

(Step S306) The thinner is supplied from the chemical solution supplying unit 410 to near the rotation center of the surface of the template 301. The thinner is spread over the entire region on the surface of the template 301 due to centrifugal force generated by the rotation of the template 301. Thereby, the alcohol remaining on the surface of the template 301 is substituted with the thinner.

(Step S307) The silane coupling agent is supplied from the chemical solution supplying unit 410 to near the rotation center of the surface of the template 301. The silane coupling agent is spread over the entire region on the surface of the template 301 due to centrifugal force generated by the rotation of the template 301. The hydrolyzable groups (e.g., methoxy groups) of the silane coupling agent have a hydrolyzable reaction with a very small amount of moisture remaining in the atmosphere or on the template 301 to form silanol groups, followed by the dehydration condensation reaction with the silanol groups on the surface of the template 301 to cause coupling reaction. Thereby, the uniform release layer is formed on the surface of the template 301.

(Step S308) The thinner is supplied from the chemical solution supplying unit 410 to near the rotation center of the surface of the template 301. The thinner is spread over the entire region on the surface of the template 301 due to centrifugal force generated by the rotation of the template 301. Thereby, the silane coupling agent remaining on the surface of the template 301 is substituted with the thinner.

(Step S309) The drying process of the template 301 is performed. For instance, the spin dry process, which shakes off the thinner remaining on the surface of the template 301 for drying by increasing the rotational speed of the template 301 to the predetermined spin dry rotational speed, is performed.

(Step S310) The template 301 is conveyed out of the second chamber 320, and is conveyed into the storing unit 380. The template 301 is stored in the storing unit 380 until the time immediately before the resist pattern forming.

In the present embodiment, in the second chamber 320, the template 301 is not dried and is wet during the period between the wet cleaning process in step S304 and the forming of the release layer in step S307. The template 301 is not exposed into the atmosphere, and organic substances can be prevented from adhering onto the surface of the template 301, so that the uniform and strong release layer can be formed.

In addition, the template 301 subjected to the surface treatment according to this embodiment is used so that the imprint quality can be improved, and the productivity of storage devices and LEDs manufactured using the imprint can be enhanced.

In the third embodiment, organic substances on the template 301 are removed by plasma ashing. However, the organic substances may be decomposed and removed by emitting an ultraviolet light, or the organic substances may be oxidatively decomposed and removed using an oxidative liquid such as fuming nitric acid, ozone water, or high-concentration ozone water. In addition, the organic substances may be removed using an organic solvent.

Further, the storing unit 380 of the surface treatment apparatus 300 may be provided in the surface treatment apparatuses 100 and 200.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A surface treatment method which processes the surface of a template including an uneven pattern surface in an environment in which amines are controlled to be in a predetermined concentration or less, comprising:
hydroxylating the surface of the template or absorbing water onto the surface to distribute OH radicals on the surface; and
coupling a coupling agent onto the surface of the template on which the OH radicals are distributed.

2. The template surface treatment method according to claim 1, further comprising removing a part of moisture on the surface of the template between the distribution of the OH radicals on the surface and the coupling of the coupling agent onto the surface of the template.

3. The template surface treatment method according to claim 2, wherein the surface of the template is heated at a temperature between 100° C. and 200° C. to remove a part of the moisture on the surface of the template.

4. The template surface treatment method according to claim 1, wherein in the coupling of the coupling agent, reaction by-products are removed during coupling reaction.

5. The template surface treatment method according to claim 4, wherein the coupling agent is supplied in vapor form, and a reaction atmosphere is circulated during the coupling reaction to remove the reaction by-products.

6. The template surface treatment method according to claim 1, further comprising removing inorganic substance particles and organic substances from the surface before the distribution of the OH radicals on the surface of the template.

7. The template surface treatment method according to claim 6, wherein organic substances are removed from the surface by plasma ashing.

8. The template surface treatment method according to claim 6, comprising:
supplying a cleaning solution onto the surface of the template to remove inorganic substance particles;
substituting the cleaning solution on the surface of the template with alcohol;
substituting the alcohol on the surface of the template with thinner;
substituting the thinner on the surface of the template with the coupling agent to couple the coupling agent onto the surface of the template; and
after the coupling of the coupling agent, drying the surface of the template.

9. The template surface treatment method according to claim 1, further comprising controlling the template so that amines have a predetermined concentration or less and the number of particles has a predetermined value or less after the coupling agent is coupled onto the surface of the template to store the template in a storing unit which is brought into an inert gas atmosphere.

10. The template surface treatment method according to claim 1, wherein the coupling agent contains silicon and is hydrocarbon or fluorocarbon, with an alkoxy group (RO—) or an NHx (x=1, 2) group at an end.

11. A pattern forming method comprising:
applying an imprint material onto a substrate to be processed;
bringing the pattern surface of a template of which surface is processed by the template surface treatment method according to claim 1 into contact with the imprint material;
curing the imprint material in the state where the template is contacted with the imprint material; and
releasing the template from the imprint material.

12. A template surface treatment apparatus comprising:
a first chamber which has a light emitting unit which emits a light onto a surface of a template having an uneven pattern surface and a first supplying unit which supplies a mixed gas of H₂O/O₂/N₂;
a second chamber which has a heating unit which heats the template and a second supplying unit which supplies a coupling agent onto the surface of the template; and
a filter which removes amines and holds the amine concentration of a gas in the apparatus to a predetermined value or less.

13. The template surface treatment apparatus according to claim 12, wherein the second supplying unit supplies a mixed gas of nitrogen and a silane coupling agent.

14. The template surface treatment apparatus according to claim 12, further comprising a third chamber having a removing unit which absorbs and removes inorganic substance particles from the surface of the template.

15. The template surface treatment apparatus according to claim 14, wherein the removing unit presses or separates an adhesive sheet onto or from the surface of the template by a pressing roll to absorb and remove the inorganic substance particles.

16. A template surface treatment apparatus comprising:
a first chamber which has a removing unit which removes organic substances from a surface of a template having an uneven pattern surface;
a second chamber which has a chemical solution supplying unit which supplies a cleaning solution, alcohol, thinner, and a coupling agent in sequence onto the surface of the template; and
a filter which removes amines and holds the amine concentration of a gas in the apparatus to a predetermined value or less.

17. The template surface treatment apparatus according to claim 16, wherein the second chamber has a drying process unit which can dry the template.

18. The template surface treatment apparatus according to claim 17,
wherein the chemical solution supplying unit supplies the coupling agent onto the surface of the template to supply the thinner,
wherein the drying process unit dries the template whose surface is wet with the thinner by a spin dry process.

19. The template surface treatment apparatus according to claim 16, wherein the removing unit performs plasma ashing.

20. The template surface treatment apparatus according to claim 16, further comprising a storing unit which stores the template conveyed out of the second chamber,
wherein the storing unit controls amines to be in a predetermined concentration or less and the number of particles to be a predetermined value or less, and is brought into an inert gas atmosphere.
